(19) United States
(12) Patent Application Publication
(10) Pub. No.: US 2002/0155249 A1
(43) Pub. Date: Oct. 24, 2002

(54) Carpet tile containing resin and bitumen

(76) Inventor: Keith Barkway Davies, Llantamam (GB)

Correspondence Address: J. Michael Martinez de Andino, Esq., HUNTON & WILLIAMS, East Tower, Riverfront Plaza, 951 East Byrd Street, Richmond, VA, 23219-4074, US

(21) Appl. No.: 10/119,861

(22) Filed: Apr. 10, 2002

Related U.S. Application Data
(62) Division of application No. 09/191,065, filed on Nov. 12, 1998.
Application No. 09/191,065 is a division of application No. 09/826,456, filed on Apr. 5, 2001.
Application No. 09/826,456 is a continuation-in-part of application No. 09/191,065, filed on Nov. 12, 1998.

(51) Int. Cl. B32B 3/02; D04H 11/00; D05C 17/00; D03D 27/00; B32B 33/00

(52) U.S. Cl. 428/85

(57) ABSTRACT

A carpet tile having a generally planar body where the body has a traffic surface and a mounting surface. A portion of the mounting surface is formed from a resin modified bitumen matrix. The matrix is effective in substantially preventing adherence of bitumen to tile forming tools, the contamination of such tools by the bitumen, or both. The matrix comprises bitumen, a predetermined amount of resin, and a predetermined amount of filler. Also provided is a method for preparing resin modified bitumen for a mounting surface of a carpet tile. The method comprises heating bitumen to a temperature between about 120° C. and about 180° C., adding a predetermined amount of resin and filler to the bitumen to form a matrix wherein the resin and filler is added in amount effective to substantially prevent adherence of bitumen to tile forming tools, and applying the matrix to the mounting surface.

### FIELD OF THE INVENTION

The present invention relates generally to fibrous floor covering material, and more particularly to carpet tiles.

### BACKGROUND OF THE INVENTION

Carpet tiles typically include a generally planar body having a traffic surface or wear layer and a mounting surface or floor contact layer. Other intermediate layers may also be included. Generally, carpet tiles are made of textile fibers normally composed of natural and or synthetic fiber materials including wool, cotton, nylon, acrylic, polypropylene or mixtures thereof. The textile fibers may be woven or tufted by any method of carpet manufacture known to one skilled in the art. After the weaving or tufting process, the unfinished carpet, generally in roll form, is precoated with a water based filled or unfilled latex or emulsion. The fibers are then firmly anchored in a primary backing. The primary backing is generally a composition based on styrene butadiene rubbers (“SBR”), styrene acrylate (“SA”) or ethylene vinyl acetate (“EVA”). After the fibers are firmly anchored in the primary backing, the carpet is ready for application of a mounting surface or back coating thereto.

Traditionally, mounting surfaces of carpet tiles have been made from one of three different types of compositions. One composition includes water-based solutions or emulsions that are filled with mineral fillers. Warm or hot air is used to remove water by evaporation and thereby dry the mounting surface.

The second composition for a mounting surface involves solvent-free systems which are liquids at ambient temperature, e.g., polyvinyl chloride (“PVC”) or plastisols. Other compositions are based on solvent-free polyurethane. These compositions are highly filled and react by a two-part method where the composition reacts via a chemical reaction accelerated by heat.

The third type of compositions are those compositions used with hot melt methods. These compositions are generally derived from polypropylene or bitumen and are generally coated onto the carpet between about 120° C. and about 200° C.

Polypropylene of the atactic type has been used successfully as a mounting surface for carpet tiles. In recent years, the high cost of atactic polypropylene has made this method less attractive.

The hot melt method based on bitumen is highly competitive with the previously mentioned methods and types of mounting surfaces but has inherent problems. Due to the inherent nature of bitumen to adhere to and contaminate tile forming tools, bitumen is not an ideal medium for carpet tile manufacturing. As used herein, “tile forming tools” or “carpet forming tools” refer to the tools used in the industry to cut or size the carpet to a final size after the mounting surface has been applied to the carpet. Tile forming tools or carpet forming tools include but are not limited to metallic cutting tools, cutting tool blades, knives, presses, die stamping cutting tools such as a Pieper die cutting tool fitted to a cutting press, and other tools known to one skilled in the art for forming, cutting, or sizing carpet tiles after the mounting surface has been applied to the carpet.

Unmodified bitumen compounds can transfer from the mounting surface of the carpet tile to tile forming tools. The transfer of bitumen to tile forming tools and retention thereby, produces sticky deposits on the tool resulting in frequent and time consuming cleaning of the tools. If the cutting tool is not clean, the bitumen contaminant can be transferred to the fibers of the carpet, which results in tiles with visible lines across the grid pattern when the tiles are laid. Soft bitumen compositions can produce marks on skirting boards, walls and can also contaminate knives used by carpet contractors when installing carpet tiles. The use of harder grades of bitumen or lower penetration grades to minimize bitumen transfer can produce compositions of bitumen that have high viscosities and require higher temperatures to process. High viscosity and higher processing temperatures for bitumen are undesirable.

In an attempt to overcome the problems associated with bitumen compositions, some companies have developed polymer modified bitumen systems. Generally, bitumen is modified with high molecular weight block polymers like styrene-butadiene-styrene, styrene-isoprene-styrene, ethylene vinyl acetate or other similar polymer. Small percentages of polymer, about 5-10%, are normally used with the polymer modified bitumen systems. The lower amount of bitumen in the mounting surface reduces bitumen contamination problems.

The polymer modified bitumen systems suffer from the use of higher cost compounds and very specialized mixing equipment to disperse the high molecular weight polymers into the bitumen. Further, due to the very high melt viscosity of these high polymers, oxidized bitumen cannot be used because the combined viscosity would be unusable at normal application temperatures. Additionally, the polymer modified bitumen system can be unstable as a solution-dispersion and may suffer from phase separation.

### SUMMARY OF THE INVENTION

It is accordingly an object of the present invention to provide a bitumen containing fibrous floor covering that is easy and economical to manufacture and does not result in the adherence of bitumen to carpet forming tools or tile forming tools.

The present invention provides a carpet tile having a generally planar body, including a traffic surface and a mounting surface. A portion of the mounting surface is formed from a matrix. The matrix comprises bitumen amount of substantially non-polymeric resin wherein the resin is effective in substantially preventing adherence of the bitumen to tile forming tools.

The present invention is also provided with a carpet tile having a generally planar body, including a traffic surface and a mounting surface. A portion of the mounting surface is formed from a matrix. The matrix comprises bitumen and an amount of resin wherein the resin is effective in substantially preventing adherence of the bitumen to tile forming tools. The resin is selected from the group consisting of polyterpene resin, coumarone-indene resin, cyclohexanone formaldehyde resin, phenolic resin, petroleum resin, phenol formaldehyde resin, and gilsonite derivatives.

Further, the present invention comprises a finished carpet tile manufactured using carpet forming tools. The finished carpet tile has a generally planar body where the body has a traffic surface and a mounting surface. A portion of the mounting surface is formed from a matrix having a total weight. The matrix comprises bitumen, a predetermined amount of resin, a predetermined amount of filler, and a fatty acid amide that is a reaction product of lauric acid and diethanolamine. The fatty acid amide that is a reaction product has an amide weight, the filler is calcium carbonate and has a filler weight, the bitumen is oxidized bitumen and has a bitumen weight, and the resin is pentaerythritol rosin ester and has a resin weight. The total weight comprises the bitumen weight, the resin weight, the filler weight, and the amide weight. The bitumen weight is about 18% of the total weight. The resin weight is about 5% of the total weight. The filler weight is about 76% of the total weight. The amide weight is about 1% of the total weight. The matrix is effective in substantially preventing adherence of the bitumen to the carpet forming tools.

The invention is also provided with a method for preparing resin modified bitumen for a mounting surface of a carpet tile. The method comprises heating bitumen to a temperature between about 120°0 C. and about 180° C., adding an amount of substantially non-polymeric resin to the bitumen to form a matrix wherein the resin is added in an amount effective to substantially prevent adherence of bitumen to tile forming tools, and applying the matrix to the mounting surface.

It is a further object of the present invention to include a film forming portion where the resin amount is up to about 80% by weight of the film forming portion and where the resin has a melting point between about 65° C. and about 150° C. Optionally, the matrix may include a film forming portion where the resin amount is between about 5% and about 30% by weight of the film forming portion and where the resin a has a melting point between about 80° C. and about 100° C. Further, the resin may have a molecular weight below about 5000.

Another object of the present invention is for the matrix to further comprise a predetermined amount of filler. The predetermined amount of filler may be between about 60% and about 120% by volume of the film forming portion. Optionally, the predetermined amount of filler is between about 100% and about 110% by volume of said film forming portion.

A further object of the present invention is for the bitumen to have a penetration between about 5 PEN and about 300 PEN and a bitumen melting point between about 75° C. and about 120° C. Preferably, the bitumen has a penetration between about 15 PEN and about 25 PEN and a bitumen melting point between about 75° C. and about 120° C.

Another object of the present invention is to provide a resin selected form the group consisting of rosin, ester gum, tall oil, esters of rosin, hydrogenated rosin, esters of hydrogenated rosin, reaction products from rosin and maleic anhydride, and reaction products from rosin and phenol. The esters of rosin may be formed from the reaction of rosin with alcohol, wherein the alcohol is selected from the group consisting of methyl alcohol, dipropylene glycol, glycerine, and pentaerythritol, or mixtures thereof.

### BRIEF DESCRIPTION OF THE DRAWINGS

FIG. 1 is a cross-sectional view of a carpet tile having tufted carpet fibers in accordance with the present invention; and

FIG. 2 is a cross-sectional view of a carpet tile having a woven traffic surface in accordance with the present invention.

### DETAILED DESCRIPTION OF THE PREFERRED EMBODIMENT

The present invention is directed to a carpet tile that uses bitumen in combination with resins to form a resin modified bitumen matrix to use in forming at least a portion of the mounting surface of the carpet tile. The resin modified bitumen matrix substantially reduces the transfer and retention of bitumen to tile forming tools.

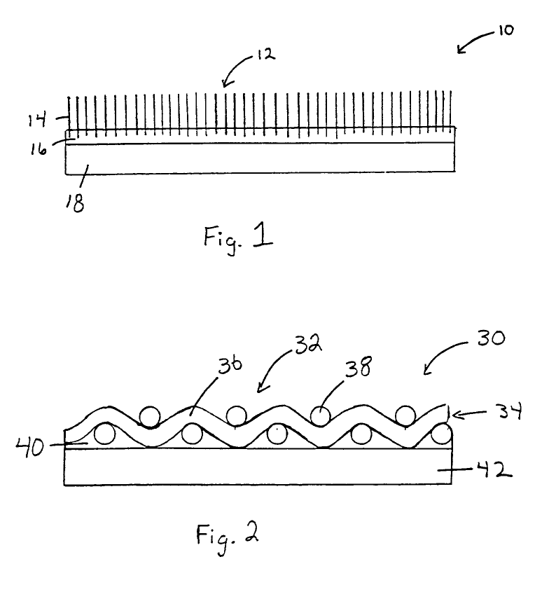

Turning now to the drawings and more particularly to FIG. 1, one preferred embodiment of a carpet tile in accordance with the present invention is illustrated generally at 10. The carpet tile 10 has a generally planar body 12. The body 12 is provided with a tufted traffic surface 14 that is firmly anchored in a primary backing 16. A mounting surface 18 is attached to the primary backing 16, opposite the tufted traffic surface 14. At least a portion of the mounting surface 18 is formed from a resin modified bitumen matrix where the matrix includes bitumen and resin. The matrix will subsequently be described in detail.

With reference now to FIG. 2, a woven carpet tile in accordance with the present invention is illustrated generally at 30. The woven carpet tile 30 has a generally planar body 32. The body 32 is provided with a woven traffic surface 34 having warp yarns 36 and weft yarns 38. The woven traffic surface 34 is firmly anchored in a primary backing 40. A mounting surface 42 is attached to the primary backing 40, opposite the woven traffic surface 34. At least a portion of the mounting surface 42 is formed from a resin modified bitumen matrix, where the matrix includes bitumen and resin.

Turning now to the resin modified bitumen matrix that makes up at least a portion of the mounting surfaces 18 and 42, and in particular, the resin for the matrix, a preferred resin is one that is substantially non-polymeric. As used herein “substantially non-polymeric” refers to a resin that is substantially monomeric when added to the bitumen and either remains substantially monomeric in the bitumen or does not result in a high molecular weight polymer when added to, mixed with, and solidified with the bitumen to form the mounting surface of a carpet tile. Preferably, the substantially non-polymeric resin maintains a molecular weight below about 5000 g/mol when mixed with and solidified with the bitumen to form the mounting surface of a carpet tile.

Preferably the non-polymeric resin is derived from rosin. Rosin is a natural resinous material derived from vegetation. The principal chemical structure in the composition is either abietic acid or pimaric acid depending on the source of the product. The rosin used in the present invention may be hydrogenated, esters of hydrogenated rosin, or combinations thereof.

The preferred form of rosin is in the reacted state with the preferred reaction being esterification but should not be limited thereto. The esters of rosin are reaction products of rosin with mono-, di-, tri-, tetra-, polyfunctional alcohols, or combinations thereof. Suitable reaction partners include, but are not limited to, methyl alcohol, dipropylene glycol, glycerine, pentaerythritol, and combinations thereof. The most preferred reaction is that of the rosin acid with alcohols to produce what is commonly known as ester gum. Further, liquid rosin, commonly known as tall oil or tallol, may also be used to produce rosin esters for use as resins in accordance with the present invention. Other resins may include reaction products from rosin with maleic anhydride or rosin and phenol.

Another group of resins that are effective in substantially preventing the adherence of the resin modified bitumen matrix to tile forming tools include polyterpene resins derived from distillation of conifers, petroleum resins, and those resins derived from various hydrocarbons including coumarone-indene resins. Cyclohexanone formaldenhyde resins are compatible with bitumen and may be used; however, they suffer from high costs in this application.

Phenolic resins including, but not limited to, novolacs have also proved to be useful in preventing the adherence of bitumen to tile forming tools. Generally, any non-heat hardening phenolic resin is applicable to the present invention, including but not limited to resins formed from the reaction products of phenol with formaldehyde. Gilsonite and its derivatives are useful as a resin in the modification of bitumen for carpet tile manufacturing in accordance with the present invention.

More generally, suitable resins are preferably crystalline by nature and normally are in solid form at room temperature. The resins should have a suitable melting point between about 65° C. and about 150° C., preferably between about 80° C. and about 100° C. These properties allow the resin to be handled at room temperature without the fear of blocking and re-solidification in a warm environment.

The matrix may contain resin in an amount of up to about 80% by weight of the film forming portion of the matrix. Preferably, the resin is between about 5% and about 30% by weight of the film-forming portion. The film forming portion of the matrix, also referred to as the binder portion, is considered to be the bitumen and the resin. The film forming portion is essentially the non-filler portion of the matrix.

Turning now to the bitumen that makes up the matrix, bitumen is available in standard, oxidized, or hardened grades. Oxidized bitumen, which is traditionally used in carpet tile manufacture, is characterized as rubber like. All oxidized bitumen is reference by the petroleum industry as “R” grades, signifying rubber like properties. Oxidized bitumen products, unlike hard bitumen, are difficult to cut. When harder or higher melting point grades of oxidized bitumen are added, major problems of high to unusable viscosity profiles occur at around 120° C.-180° C. The high viscosity allows only very low percentages of filler to be added to the bitumen. Further, higher temperatures, above about 180° C., are required to reduce the viscosity. The addition of resin to bitumen dramatically lowers the viscosity and increases the hardness of the compound instantly.

The bitumen used in this invention may have a penetration between about 5 PEN and about 300 PEN as defined in the petroleum industry. The invention may utilize standard, oxidized or hard grades, or combinations thereof. The preferred grades of bitumen are oxidized grades or mixtures of selected blends of bitumen grades that having a PEN value between about 15 to about 25 and a melting point of between about 75° C. and about 120° C.

Fillers are used in the same or similar percentage as the film forming portion of the matrix to enhance other desired properties, i.e., flame retardancy, rheology and for cost optimization. Suitable types of fillers include but are not limited to, calcium carbonate (limestone), silicates, silicas, oxides of silica, carbonates, sulfates, oxides of antimony, aluminum trihydrate, flourates, chlorates, borates, and phosphates, as well as other types of fillers known to one skilled in the art. The particle size of the fillers may range between about 0.01 micron and about 1.00 millimeter in size and may be segregated or classified to produce a desired mean size.

The filler content in the present invention is at a level of between about 10% and about 90% by weight based on the weight of the resin modified bitumen matrix. The filler levels in the resin modified bitumen systems are normally extremely high, preferably on the order of about 70% to about 80% by weight of the resin modified bitumen matrix. For comparison, polymer modified bitumen systems are normally at the most about 50% to about 60% filler by weight. This high filler loading for the resin modified bitumen matrix has a drying effect on the binder. However, the filler drying effect alone does not overcome the elimination of bitumen contamination. The addition of the resin is the driving force in eliminating bitumen contamination, the addition of filler to the matrix reduces the cost in manufacturing the tile.

The filler volume concentration, the percentage of filler volume per bitumen and resin volume in the matrix, is preferably between about 60% and about 120%. Exceeding the maximum filler loading will result in a matrix that is too thick. Alternatively, lowering the filler loading will result in a drop in viscosity but the cost increases accordingly. Most preferably, the filler volume concentration is between about 100% and about 110%, which equates to about 70% to about 80% of filler by weight of the total composition. Preferably, for every volume of bitumen and resin in the system, an equal volume of filler is present.

Surfactants may be used with the present invention and can be useful in wetting the filler content, managing the melting point of the matrix, or controlling antistatic performance of the carpet tile. The surfactant allows efficient dispersion of the filler when added to the matrix. Useful surfactants include glycerol mono streatrate; ethoxylates; glycolates; sulphonates; a surfactant that is a fatty acid amide, which is a reaction product of lauric acid and diethanolamine; and LANKROSTAT® 104 commercially available from AKCROS Chemicals Ltd., Bentcliffe Way, Eccles, Manchester, United Kingdom. LANKROSTAT® is a registered trademark of Harcros Chemicals UK Limited.

Preferably, the surfactant has a melting point above about 40° C. Most preferably, the surfactant has a melting point above about 60° C. The warmer the climate, the higher the melting point of the surfactant needs to be in order to prevent creep or edge melt of the matrix from the sides of the tile. Creep is a phenomenon where tiles that are exposed to high ambient temperatures start to exude bitumen from the edges of the tile.

Natural and synthetic waxes may be added to the resin modified bitumen matrix and can be useful in reducing the viscosity and allowing for an increase in the filler content. These waxes include, but are not limited to, hydrocarbons derived from the distillation of petroleum, paraffin wax and microcrytaline waxes with melting points ranging from about 45° C. to about 1200°0 C. Natural waxes of the candelilla and carnauba type are also useful.

Other additives such as pigments plasticisers, and other high molecular weight polymers, including polymers and co-polymers of ethylene, propylene, styrene, vinyl acetate, butadiene and generic rubber elastomers, may also be added in low proportions to the matrix.

When preparing the resin modified bitumen matrix, the bitumen is pumped into a heated jacketed vessel at a temperature of between about 120° C. and about 180° C. The resin is added in solid form and rapidly dissolves into the hot bitumen. The bitumen viscosity then reduces proportionally to the amount of resin added. A surfactant and wax may be added and dissolved in the resin modified bitumen matrix.

The hot resin modified bitumen liquid is now ready to receive the filler. The filler has a cooling effect or quench effect on the matrix due to the filler being at ambient temperature. The filler reduces the starting mix temperature by approximately 20-30° C. The temperature quenching effect is dramatic in increasing the viscosity. Since the base viscosity of the matrix is lowered due to addition of the resin, the quench effect is controlled and there is not a dramatic increase in viscosity of the matrix.

The filler is added and mixed until a smooth and well-dispersed matrix is obtained. To accomplish mixing, the resin modified bitumen matrix is stirred at low speeds of about one hundred revolutions per minute or less. The molten matrix is then ready for pumping to a carpet coating apparatus.

Bitumen backed carpet tiles at present are manufactured by first applying a primary backing to the tufted or woven textile fibers. The resin modified bitumen matrix is then applied as a mounting surface to the primary backing. The matrix is applied between about 500 grams per square meter and about 5000 grams per square meter. Preferably, the matrix is applied at about 3000 grams per square meter. Optionally, the resin modified bitumen matrix may be added to the carpet, to a carrier tissue, or on a conveyor belt on which the carpet is laid. Within the application process, a dimensional stabilizing tissue may be used which may be non-woven glass tissue or other specified material. The composition is cooled and then cut either online or with stand-alone presses and made into carpet tiles.

The use of resin as an addition to the bitumen has many advantages over straight bitumen-limestone, or polymer modified bitumen in carpet tile manufacturing. Unlike polymer modified bitumen, the resin modified bitumen method reduces the viscosity of the binder and hardens the composition at the same time. The resins due to their crystalinity are hard, brittle and have a very low tensile strength at room temperature. These properties of the resin aid in carpet tile cutting when the shear action of the blades takes place.

By utilization of the present invention, contamination of cutting blades with bitumen is substantially eliminated with no substantial transfer of unwanted black bitumen to the edges of the tile. Carpet tile production can run continuously without stopping to clean cutting tools. The tiles may be cut through the face or through the back of the carpet. The cutting edge of the carpet tile remains sharp, straight, and clean. The abutment of tile edges results in carpet tiles that have an excellent broadloom appearance. No visible seam can be seen when tiles are laid together in the normal fashion.

Depending on the resin selected, the compatibility with bitumen is generally excellent and no phase layering is experienced. This can be a major problem as in some polymer modified bitumen types, which have to be mixed under very expensive high speed or high shear equipment. Constant heat in polymer modified bitumen type compounds can lead to phase separation and polymeric depolymerisation. Hot resin modified bitumen matrices or compositions are thermally stable, maintain a physically steady state and do not suffer from phase separation or thermal degradation.

The resin modified bitumen matrix does not suffer from thermal depolymerisation, unwanted side reactions or phase separation unlike the polymer modified bitumen systems. For the temperatures that are normally used in carpet tile processing, about 120° C. to about 165° C., special high speed or high shear mixers are not required. This has great financial benefits of allowing the equipment that was used for manufacturing straight bitumen-limestone compounds to be used for manufacturing the resin modified bitumen matrix. Another advantage of the present invention is that no time limit is placed on holding a batch of resin modified bitumen over several weeks of continual heating. Further, carpet tiles produced from using resin modified bitumen do not suffer from edge melt or creep problems.

The resin modified bitumen method also introduces another important performance improvement over polymer modified bitumen systems in the form of filler acceptance. Filler levels may be increased to higher percentages than were previously realized. The level of filler has an important effect on lowering the cost of the bitumen mounting surface. Further, when the filler is combined with resin in the bitumen matrix, the combination has an effect of lowering the inherent property of bitumen to mark surfaces. Of particular importance once again are metallic cutting tools and cutting die tool knives. When the knife cuts through the bitumen layer, the knife collects deposits of bitumen from the backing or mounting surface. This is due to the rubbery or viscoelastic nature of oxidized bitumen. When the knives are contaminated, the bitumen builds up on the knife and transfers bitumen to the edge of the carpet tile and results in contamination. This results in carpet tiles that have a thin film of bitumen present on the edges, resulting in the appearance of a checkerboard rather than a broadloom appearance.

Carpet tiles using resin modified bitumen leave tile forming tools substantially free from bitumen contamination. The resultant carpet tiles are superior to bitumen-only and polymer modified bitumen systems. Uncomplicated mixing equipment may be used with resin modified bitumen systems, which makes it more economical to manufacture bitumen carpet backing systems. This novel method and composition of manufacture of bitumen for carpet manufacture has many advantages over traditional and polymer modified bitumen systems.

The following examples are provided to illustrate the present invention and should not be construed as limiting thereof.

### EXAMPLE 1

A tufted carpet is manufactured by tufting nylon yards 800 grams-1500 grams per square meter through a primary backing. This is normally between 80 grams to 150 grams per square meter and made from spun bonded polyester. The carpet is then precoated with a suitable emulsion or latex compound in order to anchor the tufts in place. This is the normal method for producing tufted carpets. In roll form, the carpet is passed through a hot coating bitumen application line. The hot resin modified bitumen matrix is applied directly to a back carpet surface, backing tissue or conveyor belt. Then the carpet is then placed onto hot coating. The incorporation of stabilizing unwoven glass tissue, glass crinett may also be used to stabilize the finished carpet tile from dimensional changes through the effect of temperature variances and humidity variances. The hot bitumen composition is then applied at the rate of 3000 grams per square meter to the carpet or carrier tissue.

The resin modified bitumen matrix (150° C.) is pumped onto a moving conveyor via a rolling bank with the tissue or carpet under surface running under the hot composition. The resin modified bitumen matrix, carpet, tissue and stabilizing scrim are then pressed together using a nip roller. The carpet, with the multi layers in place, passes along a cooling platen or plates until the carpet reaches room temperature. When the carpet is around ambient temperature, the roll of carpet may be cut on line or planked off and cut through stand-alone presses.

The following matrix was used:

| | Percent by Weight |
|---|---|
| Oxidized bitumen | 19.50% |
| Pentaerythritol rosin ester | 4.50% |
| Fatty acid amide | 0.50% |
| Polyethyene wax | 0.50% |
| Limestone (calcium carbonate) | 75.00% |
| TOTAL | 100.00% |

The oxidized bitumen grade is R95/25 and has a melting point of 95° C. and a PEN penetration index of 25. The pentaerythritol rosin ester has a melting point of 100° C. with an acid value of four. The fatty acid amide is LANKROSTAT® 104. The polyethylene wax has a melting point of 100° C.

The molten bitumen backing has a viscosity of about 30,000 to 100,000 centi poises at 150° C. The composition has a density of 1.85 grams per cubic centimeter and a penetration hardness that is lower than 7 millimeters. In this way, hardness of the composition is greatly increased compared to the original hardness of the raw bitumen. The flexibility of the carpet tile is good enough to flex during normal manufacture and fitting despite the resin modified bitumen matrix being much harder than raw bitumen.

Tiles produced from this composition are cut by a normal press method or by a rotary cutting method. The result is the steel blade or rotors, even after prolonged running, are substantially free from bitumen contamination and no substantial amount of bitumen is transferred to the carpet tile. The edge of the tile remains sharp, straight and clean. When in abutment with an adjacent tile an excellent fit and appearance is achieved.

### EXAMPLE 2

Using the procedure from the previous example, the following resin modified bitumen matrix was used:

| | Percent by Weight |
|---|---|
| Oxidized bitumen | 20.00% |
| Pentaerythritol rosin ester | 4.00% |
| Fatty acid amide | 1.50% |
| Polyethyene wax | 0.50% |
| Limestone (calcium carbonate) | 74.00% |
| TOTAL | 100.00% |

The oxidized bitumen grade is R95/15 and has a melting point of 95° C. and a PEN penetration index of 15. The pentaerythritol rosin ester has a melting point of 100°0 C. with an acid value of four. The fatty acid amide is LANKROSTAT® 104. The polyethylene has a melting point of 100°0 C.

The molten bitumen matrix has a viscosity of about 30,000 to 100,000 centi poises at 150° C. The composition has a density of 1.85 grams per cubic centimeter at 20° C. and a penetration hardness that is lower than 7 millimeters at 20° C. In this way, hardness of the composition is greatly increased compared to the original hardness of the raw bitumen. The flexibility of the carpet tile is good and the carpet tile will flex during normal manufacture and fitting.

Tiles produced from this matrix are cut by a normal press method with a heated die or by a rotary cutting method. The result is that the steel blade or rotors, even after prolonged running, are substantially free from any contamination of bitumen and no substantial amount of bitumen is transferred to the carpet tile. The edge of the tile remains sharp, straight and clean. When in abutment with an adjacent tile an excellent fit and appearance is achieved.

### EXAMPLE 3

Using the same procedure as in the previous examples, the following resin modified bitumen matrix was used:

| | Percent by Weight |
|---|---|
| Oxidized bitumen | 18.00% |
| Pentaerythritol rosin ester | 5.00% |
| Fatty acid amide | 1.00% |
| Limestone (calcium carbonate) | 76.00% |
| TOTAL | 100.00% |

The oxidized bitumen grade is R95125 and has a melting point of 100°0 C. with an acid value of four. The fatty acid amide is LANKROSTAT® 104. The polyethylene wax has a melting point of 100° C.

The 150° C. molten resin modified bitumen matrix has a viscosity of about 30,000 to 100,000 centi poises. The matrix has a density of 1.85 grams per cubic centimeter at 20° C. and a penetration hardness that is lower than 7 millimeters at 20° C. In this way, hardness of the matrix is greatly increased compared to the original hardness of the raw bitumen. The carpet tile will flex during normal manufacture and fitting.

Tiles produced from this composition are cut on a normal press, with or without the heated die or by a rotary cutting method. The result is the steel blade or rotors, even after prolonged running, are substantially free from bitumen contamination and there is no substantial amount of bitumen transferred to the carpet tile. The edge of the tile is substantially free from bitumen contamination and the edge of the tile remains sharp and straight. As with the previous examples, when in abutment with an adjacent tile an excellent fit and appearance is achieved.

Those persons skilled in the art will therefore readily understand that the present invention is susceptible of a broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A carpet tile comprising a generally planar body, said body having a traffic surface and a mounting surface, said mounting surface having at least a portion thereof formed from a matrix, said matrix comprising bitumen and an amount of a substantially non-polymeric resin, wherein said resin is effective in substantially preventing adherence of said bitumen to tile forming tools.

2. A carpet tile according to claim 1 wherein said matrix includes a film forming portion wherein said resin amount is up to about 80% by weight of said film forming portion and wherein said resin has a resin melting point between about 65° C. and about 150° C.

3. A carpet tile according to claim 1 wherein said resin has a molecular weight below about 5000.

4. A carpet tile according to claim 1 wherein the matrix further comprises a predetermined amount of filler.

5. A carpet tile according to claim 4 wherein said predetermined amount of filler is between about 60% and about 120% by volume of said film forming portion.

6. A carpet tile according to claim 5 wherein said matrix includes a film forming portion wherein said bitumen has a penetration between about 5 PEN and about 300 PEN and a bitumen melting point between about 75° C. and about 120° C.

7. A carpet tile according to claim 1 wherein said resin is selected from the group consisting of rosin, ester gum, tall oil, esters of rosin, hydrogenated rosin, esters of hydrogenated rosin, reaction products from rosin and maleic anhydride, and reaction products from rosin and phenol.

8. A carpet tile according to claim 7 wherein said matrix includes a film forming portion wherein said resin amount is up to about 80% by weight of said film forming portion and wherein said resin has a resin melting point between about 65° C. and about 150° C.

9. A carpet tile according to claim 8 wherein the matrix further comprises a predetermined amount of filler.

10. A carpet tile according to claim 9 wherein said predetermined amount of filler is between about 60% and about 120% by volume of said film forming portion.

11. A carpet tile according to claim 10 wherein said predetermined amount of filler is between about 100% and about 110% by volume of said film forming portion.

12. A carpet tile according to claim 10 wherein said bitumen has a penetration between about 5 PEN and about 300 PEN and a bitumen melting point between about 75°0 C. and about 120°0 C.

13. A carpet tile according to claim 7 wherein said esters of rosin are formed from a reaction of rosin with alcohol, wherein said alcohol is selected from the group consisting of methyl alcohol, dipropylene glycol, glycerine, and pentaerythritol, or mixtures thereof.

14. A carpet tile according to claim 13 wherein said matrix includes a film forming portion wherein said resin amount is up to about 80% by weight of said film forming portion and wherein said resin has a resin melting point between about 65° C. and about 150° C.

15. A carpet tile according to claim 14 wherein the matrix further comprises a predetermined amount of filler.

16. A carpet tile according to claim 15 wherein said predetermined amount of filler is between about 60% and about 120% by volume of said film forming portion.

17. A carpet tile according to claim 16 wherein said predetermined amount of filler is between about 100% and about 110% by volume of said film forming portion.

18. A carpet tile according to claim 16 wherein said bitumen has a penetration between about 5 PEN and about 300 PEN and a bitumen melting point between about 75° C. and about 120° C.

19. A carpet tile according to claim 1 wherein said resin is an ester of rosin.

20. A carpet tile according to claim 19 wherein said esters of rosin are formed from a reaction of rosin with alcohol, wherein said alcohol is selected from the group consisting of methyl alcohol, dipropylene glycol, glycerine, and pentaerythritol, or mixtures thereof.

21. A carpet tile according to claim 7 wherein said matrix includes a film forming portion and wherein said resin is in an amount between about 5% and about 30% by weight of said film forming portion and wherein said resin has a resin melting point between about 80° C. and about 100° C.

22. A carpet tile according to claim 21 wherein the matrix further comprises a predetermined amount of filler.

23. A carpet tile according to claim 22 wherein said predetermined amount of filler is between about 60% and about 120% by volume of said film forming portion.

24. A carpet tile according to claim 23 wherein said predetermined amount of filler is between about 100% and about 110% by volume of said film forming portion.

25. A carpet tile according to claim 23 wherein said bitumen is oxidized bitumen and has a penetration between about 15 PEN and about 25 PEN and a bitumen melting point between about 75° C. and about 120° C.

26. A carpet tile according to claim 21 wherein said esters of rosin are formed from a reaction of rosin with alcohol, wherein said alcohol is selected from the group consisting of methyl alcohol, dipropylene glycol, glycerine, and pentaerythritol, or mixtures thereof.

27. A carpet tile according to claim 26 wherein said matrix includes a film forming portion wherein said resin amount is up to about 80% by weight of said film forming portion and wherein said resin has a resin melting point between about 65° C. and about 150° C.

28. A carpet tile according to claim 27 wherein the matrix further comprises a predetermined amount of filler.

29. A carpet tile according to claim 28 wherein said predetermined amount of filler is between about 60% and about 120% by volume of said film forming portion.

30. A carpet tile according to claim 29 wherein said predetermined amount of filler amount is between about 100% and about 110% by volume of said film forming portion.

31. A carpet tile according to claim 29 wherein said bitumen is oxidized bitumen and has a penetration between about 15 PEN and about 25 PEN and a bitumen melting point between about 75° C. and about 120° C.

32. A carpet tile comprising a generally planar body, said body having a traffic surface and a mounting surface, said mounting surface having at least a portion thereof formed from a matrix, said matrix comprising bitumen and an amount of a resin, wherein said resin is effective in substantially preventing adherence of said bitumen to tile forming tools, and wherein the resin is selected from the group consisting of polyterpene resin, coumarone-indene resin, cyclohexanone formaldehyde resin, phenolic resin, petroleum resin, phenol formaldehyde resin, and gilsonite derivatives.

33. A carpet tile according to claim 32 wherein said matrix includes a film forming portion wherein said resin amount is up to about 80% by weight of said film forming portion and wherein said resin has a resin melting point between about 65° C. and about 150° C.

34. A carpet tile according to claim 33 wherein the matrix further comprises a predetermined amount of filler.

35. A carpet tile according to claim 34 wherein said predetermined amount of filler is between about 60% and about 120% by volume of said film forming portion.

36. A carpet tile according to claim 35 wherein said predetermined amount of filler is between about 100% and about 110% by volume of said film forming portion.

37. A carpet tile according to claim 35 wherein said bitumen has a penetration between about 5 PEN and about 300 PEN and a bitumen melting point between about 75° C. and about 120° C.

38. A finished carpet tile manufactured using carpet forming tools, said carpet tile comprising a generally planar body, said body having a traffic surface and a mounting surface, said mounting surface having at least a portion thereof formed from a matrix having a total weight, said matrix comprising:
bitumen;
a predetermined amount of resin;
a predetermined amount of filler; and
a fatty acid amide that is a reaction product of lauric acid and diethanolamine, wherein:
said fatty acid amide that is the reaction product having an amide weight;
said filler is calcium carbonate and has a filler weight,
said bitumen is oxidized bitumen and has a bitumen weight;
said resin is pentaerythritol rosin ester and has a resin weight; and
said total weight includes said bitumen weight, resin weight, filler weight, and amide weight, wherein:
said bitumen weight is about 18% of the total weight;
said resin weight is about 5% of the total weight;
said filler weight is about 76% of the total weight; and
said amide weight is about 1% of the total weight; and wherein said matrix is effective in substantially preventing adherence of said bitumen to said carpet forming tools.

39. A method for preparing resin modified bitumen for a mounting surface of a carpet tile comprising:
heating bitumen to a temperature between about 120° C. and about 180° C.;
adding an amount of a substantially non-polymeric resin to said bitumen to form a matrix, wherein said resin is added in an amount effective to substantially prevent adherence of bitumen to tile forming tools; and
applying said matrix to said mounting surface.

40. A method of claim 39 wherein the resin is selected from the group consisting of rosin, ester gum, tall oil, esters of rosin, hydrogenated rosin, esters of hydrogenated rosin, reaction products from rosin and maleic anhydride, and reaction products from rosin and phenol
